(19) United States
(12) Patent Application Publication
(10) Pub. No.: US 2025/0095419 A1
(43) Pub. Date: Mar. 20, 2025

(54) CONTROLLER

(71) Applicant: SUBARU CORPORATION, Tokyo (JP)

(72) Inventors: Yutaka MAEDA, Tokyo (JP); Yoichi FURUYA, Tokyo (JP); Hisao IMAIZUMI, Tokyo (JP); Yuta SASAKI, Tokyo (JP); Hiroyuki KOBAYASHI, Tokyo (JP); Yukio KOJIMA, Tokyo (JP); Masayuki KANEKO, Tokyo (JP); Naotoshi YOSHIKAWA, Tokyo (JP); Katsuya SHINNO, Tokyo (JP); Takafumi ITAGAKI, Tokyo (JP); Shota KAWAMURA, Tokyo (JP); Kazuyuki KONDO, Tokyo (JP)

(73) Assignee: SUBARU CORPORATION, Tokyo (JP)

(21) Appl. No.: 18/810,837

(22) Filed: Aug. 21, 2024

(30) Foreign Application Priority Data
Sep. 14, 2023 (JP) 2023-149442

(51) Int. Cl. G07C 5/08; G01M 7/02; G01M 17/007

(52) U.S. Cl. CPC G07C 5/0808; G01M 7/02; G01M 17/007

(57) ABSTRACT

A controller for a vehicle equipped with a motor for running includes one or more processors and one or more recording media storing a program to be executed by the one or more processors. The program includes one or more instructions configured to cause the one or more processors to perform a sweep driving process including sweeping an excitation frequency of vibration applied to a vehicle body of the vehicle by the motor while driving the motor during an inspection of the vehicle.

### CROSS-REFERENCE TO RELATED APPLICATION

The present application claims priority from Japanese Patent Application No. 2023-149442 filed on Sep. 14, 2023, the entire contents of which are hereby incorporated by reference.

### BACKGROUND

The disclosure relates to a controller for a vehicle equipped with a motor for running and more particularly, to a technique to drive the motor to vibrate a vehicle body.

When a vehicle is running, abnormal sounds such as a scrape of components against each other and a squeak sometimes cause inconvenience. When such an abnormal sound occurs and a mechanic from a dealer inspects the cause of the abnormal sound, the mechanic drives a client's vehicle on a public road and reproduces the abnormal sound to identify the source of the abnormal sound. However, such a task prevents the mechanic from concentrating on driving, and in addition, driving the client's vehicle on a public road may increase the possibility of an unfortunate event such as an accident.

To diagnose an abnormal sound, a vibration exciter may be used to reproduce vibration that has occurred during running, and in such a case, the mechanic does not have to drive the vehicle, decreasing the possibility of causing an unfortunate event such as an accident. Unfortunately, a vibration exciter is expensive.

Japanese Patent No. 5350305 proposes a method in which a jig is fixed near an engine mount in a vehicle equipped with an engine, which is the power source to drive wheels, so that the vibration of the engine is directly transmitted to the vehicle body and an abnormal sound is reproduced by vibrating the vehicle body using the vibration of the engine.

This method enables an abnormal sound to be reproduced at a low cost without using a vibration exciter.

### SUMMARY

An aspect of the disclosure provides a controller for a vehicle equipped with a motor for running. The controller includes one or more processors and one or more recording media storing a program to be executed by the one or more processors. The program includes one or more instructions configured to cause the one or more processors to perform a sweep driving process including sweeping an excitation frequency of vibration applied to a vehicle body of the vehicle by the motor while driving the motor during an inspection of the vehicle.

### BRIEF DESCRIPTION OF THE DRAWINGS

The accompanying drawings are included to provide a further understanding of the disclosure and are incorporated in and constitute a part of this specification. The drawings illustrate an embodiment and, together with the specification, serve to describe the principles of the disclosure.

FIG. 1 is a diagram illustrating an example of a configuration of an inspection system according to an embodiment;

FIG. 2 is a diagram for describing an example of a configuration of a vehicle control system according to the embodiment;

FIG. 3 illustrates an example of a start screen for inspection;

FIG. 4 illustrates an example of a sweep setting screen;

FIGS. 5A, 5B, and 5C illustrate an example of a method of generating a rotation-speed instruction signal to achieve sweep driving;

FIG. 6 illustrates an example of a sweep-in-progress screen;

FIG. 7 illustrates an example of a constant-frequency setting screen;

FIG. 8 illustrates an example of a rotation-in-progress screen;

FIG. 9 is a flowchart illustrating an example of procedures for implementing a method of reproducing an abnormal sound according to the embodiment;

FIG. 10 is a continuation of the flowchart in FIG. 9 illustrating the example of the procedures for implementing the method of reproducing an abnormal sound according to the embodiment;

FIG. 11 illustrates a schematic representation of waveforms for controlling a vibration excitation force using the rotation speed of a motor;

FIG. 12 illustrates a schematic representation of waveforms for controlling a vibration excitation force using a range of rotation-speed change of a motor; and

FIG. 13 illustrates a jig for joining a power unit including the motor to a body frame.

### DETAILED DESCRIPTION

In the method disclosed in Japanese Patent No. 5350305, the vehicle body is simply vibrated mainly at a rotation frequency of the engine and its harmonics, and such frequencies sometimes do not coincide with resonance frequencies of the components, and the attempt to reproduce an abnormal sound may fail.

In addition, using the engine to produce vibration causes difficulty in continuously exciting vibration at a constant frequency.

It is desirable to dispense with a vibration exciter to reduce cost for reproducing an abnormal sound safely without actually driving a vehicle and also improve the reproducibility of the abnormal sound.

In the following, an embodiment of the disclosure is described in detail with reference to the accompanying drawings. Note that the following description is directed to an illustrative example of the disclosure and not to be construed as limiting to the disclosure. Factors including, without limitation, numerical values, shapes, materials, components, positions of the components, and how the components are coupled to each other are illustrative only and not to be construed as limiting to the disclosure. Further, elements in the following example embodiment which are not recited in a most-generic independent claim of the disclosure are optional and may be provided on an as-needed basis. The drawings are schematic and are not intended to be drawn to scale. Throughout the present specification and the drawings, elements having substantially the same function and configuration are denoted with the same numerals to avoid any redundant description.

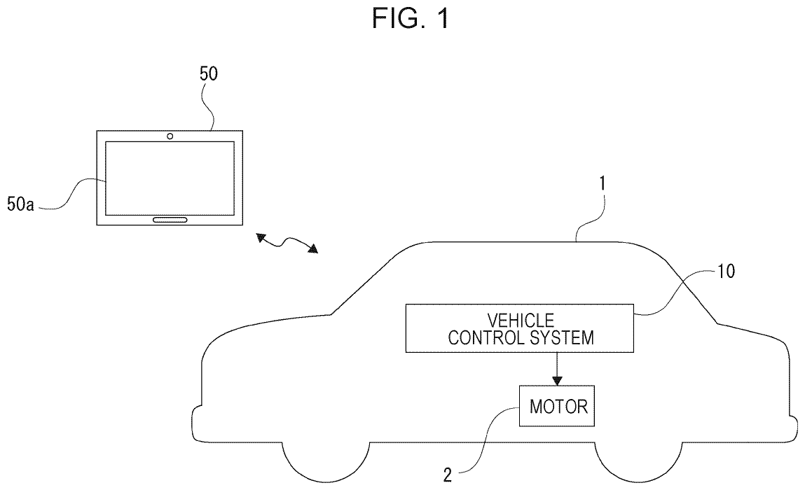

FIG. 1 is a diagram illustrating an example of a configuration of an inspection system according to the embodiment.

FIG. 1 illustrates constituent elements related to the embodiment of the disclosure that are extracted from the various constituent elements included in a vehicle 1.

As illustrated, the inspection system includes the vehicle 1 and an inspection apparatus 50 external to the vehicle 1.

The inspection system described here is configured to diagnose an abnormal sound generated while the vehicle 1 is running.

The vehicle 1 is an electrically driven vehicle equipped with a motor 2 as the power source to drive wheels. In other words, the vehicle 1 includes the motor 2 for running.

In this example, the vehicle 1 is a four-wheel vehicle having four wheels and is a so-called electric vehicle (EV) equipped with the motor 2 as a single power source to drive wheels.

The vehicle 1 may be a hybrid electric vehicle (HEV) having an engine together with the motor 2 (in such a case, the engine may be used as a power source to drive wheels or as a generator to generate electric power to drive the motor 2). Further, the vehicle 1 is not limited to a four-wheel vehicle and is assumed to have two wheels or more.

The vehicle 1 includes a vehicle control system 10 including one or more computing apparatuses to control the vehicle 1. The vehicle control system 10 is configured to perform drive control of the motor 2 as one of the functions of the vehicle control system 10.

The vehicle control system 10 is also configured to exchange various kinds of data with an apparatus external to the vehicle 1. In particular, the vehicle control system 10 is able to perform data communication with the inspection apparatus 50.

The inspection apparatus 50 includes, for example, a microcomputer equipped with a central processing unit (CPU), a read-only memory (ROM), and a random-access memory (RAM) and is assumed to be able to perform various processes related to an inspection of the vehicle 1.

The inspection apparatus 50 includes a display such as a liquid crystal display (LCD) or an organic electroluminescence (EL) display, which is not illustrated in detail, and is able to present various kinds of information to a user. For example, a graphical user interface (GUI) including various setting screens regarding an inspection and a menu screen may be displayed to enable the user to perform various input operations regarding the inspection.

A display screen of the display included in the inspection apparatus 50 is referred to as a “display screen 50a” hereinafter.

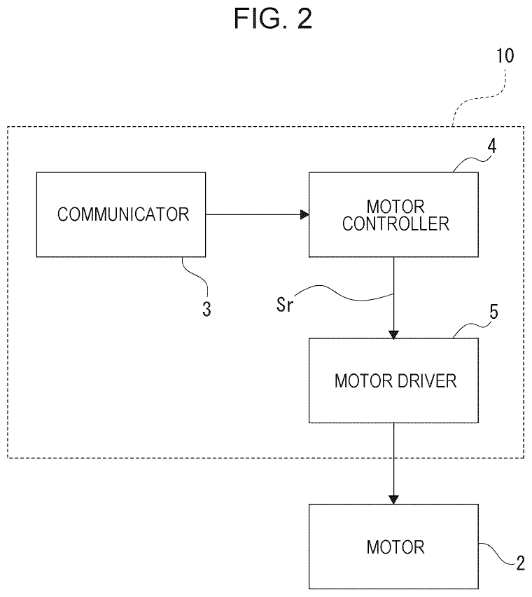

FIG. 2 is a diagram for describing an example of a configuration of the vehicle control system 10 according to the embodiment and illustrates the motor 2 depicted in FIG. 1 along with the example of the configuration of the vehicle control system 10.

FIG. 2 illustrates constituent elements related to the embodiment of the disclosure that are extracted from the various constituent elements included in the vehicle control system 10.

As illustrated, the vehicle control system 10 includes a communicator 3, a motor controller 4, and a motor driver 5.

The communicator 3 is configured to perform data communication with an apparatus external to the vehicle 1, in particular, with the inspection apparatus 50 in the embodiment. In this example, the data communication with the inspection apparatus 50 is assumed to be wireless data communication but may be wireline data communication.

The motor controller 4 includes, for example, a microcomputer equipped with a CPU, a ROM, and a RAM, and the CPU is configured to execute processes in accordance with the programs stored in the ROM and perform various kinds of control regarding the operation of the motor 2.

The motor controller 4 is able to generate a rotation-speed instruction signal Sr to provide an instruction on the rotation speed of the motor 2.

The motor driver 5 includes a driving circuit for the motor 2 and a control circuit, such as an integrated circuit (IC), configured to control the driving circuit, and the motor driver 5 is configured to drive the motor 2 in accordance with an instruction from the motor controller 4.

In particular, the motor driver 5 is configured to, while an abnormal sound is being diagnosed, drive the motor 2 so that the motor 2 rotates at a rotation speed specified by the rotation-speed instruction signal Sr generated and output by the motor controller 4.

The motor controller 4 is configured to transition to an operation mode as an inspection mode in response to an instruction from the inspection apparatus 50 while the inspection apparatus 50 is communicatively coupled to the vehicle control system 10 by the communicator 3 to diagnose an abnormal sound.

The motor controller 4 is configured to control the operation of the motor 2 in accordance with an instruction from the inspection apparatus 50 during the inspection mode.

As described above, the inspection apparatus 50 is configured to cause the display screen 50a to display a GUI to perform an operation for the inspection while an abnormal sound is being diagnosed.

In the embodiment, an abnormal sound is diagnosed while the vehicle 1 is stopped in a maintenance facility including, for example, a dealer's facility.

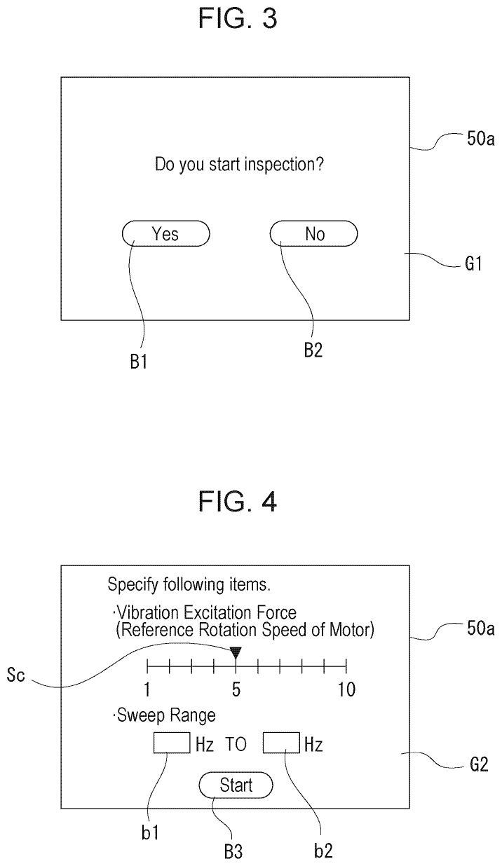

Referring to FIG. 3 to FIG. 8, description will be given with regard to examples of various GUI screens displayed by the display screen 50a during the inspection and a process performed by the motor controller 4 in response to an operation on a GUI screen.

FIG. 3 illustrates an example of a start screen G1 for inspection displayed by the display screen 50a.

The start screen G1 is displayed after the inspection apparatus 50 is communicatively coupled to the motor controller 4 by the communicator 3.

As illustrated in FIG. 3, the start screen G1 displays a message such as “Do you start inspection?” to ask the user whether to start an inspection along with a “Yes” button B1 and a “No” button B2.

The user such as a mechanic operates the “Yes” button B1 to start an inspection.

Note that, in response to the “No” button B2 being operated, the display screen 50a displays a GUI screen one level higher such as a screen for selecting the type of inspection including, for example, an inspection regarding an event other than an abnormal sound.

In response to the “Yes” button B1 being operated in the start screen G1, the display screen 50a displays a sweep setting screen G2 illustrated in FIG. 4.

In the embodiment, to reproduce an abnormal sound that has occurred while the vehicle 1 is running, the motor 2 is used to vibrate the vehicle body to generate the abnormal sound. For example, the embodiment provides a method of sweeping (continuously changing) the excitation frequency of vibration applied to the vehicle body by the motor 2 and trying to reproduce the abnormal sound.

Sweeping the excitation frequency of vibration applied to the vehicle body while the motor 2 is being driven is referred to as “sweep driving” below.

In this example, parameters regarding such sweep driving may be specified by a user operation. In this example, the sweep range of the excitation frequency of vibration may be specified by a user operation. In addition, the vibration excitation force applied during a sweep may also be specified by a user operation in this example.

As illustrated in FIG. 4, the sweep setting screen G2 displays an input box b1 and an input box b2 for specifying the sweep range of the excitation frequency of vibration and a specifying operation element Sc for specifying the vibration excitation force to be applied to the vehicle body during the sweep.

In this example, both the lowest frequency and the highest frequency of the sweep range may be specified, and the input box b1 is disposed to specify the lowest frequency while the input box b2 is disposed to specify the highest frequency. The user enters frequency values into the input boxes b1 and b2 to specify the sweep range.

A value of the vibration excitation force is selected from predetermined multiple values in this example and is selected, for example, from 10 values. FIG. 4 illustrates an example of a GUI in which a scale represents available values of the vibration excitation force and the specifying operation element Sc points to a position on the scale to specify a value of the vibration excitation force. The UI for specifying the vibration excitation force is not limited to this type, and various types of UI including entering a numerical value and turning a dial to specify a value are possible.

The GUI for specifying the sweep range is not limited to entering numerical values, either, and other types of GUI including, for example, pointing to a position corresponding to the lowest frequency and a position corresponding to the highest frequency on a scale representing the frequency may be adopted.

The sweep setting screen G2 displays a start button B3.

The user specifies the sweep range by entering numerical values into the input boxes b1 and b2 described above and specifies the vibration excitation force using the specifying operation element Sc, and thereafter the user operates the start button B3 when starting sweep driving.

The inspection apparatus 50 is configured to, in response to the start button B3 being operated, provide the motor controller 4 with an instruction to start sweep driving. The instruction to start sweep driving is accompanied by the information specified in the sweep setting screen G2, such as the information regarding the sweep range and the information regarding the vibration excitation force.

The motor controller 4 is configured to generate the rotation-speed instruction signal Sr for achieving sweep driving in response to the instruction to start sweep driving.

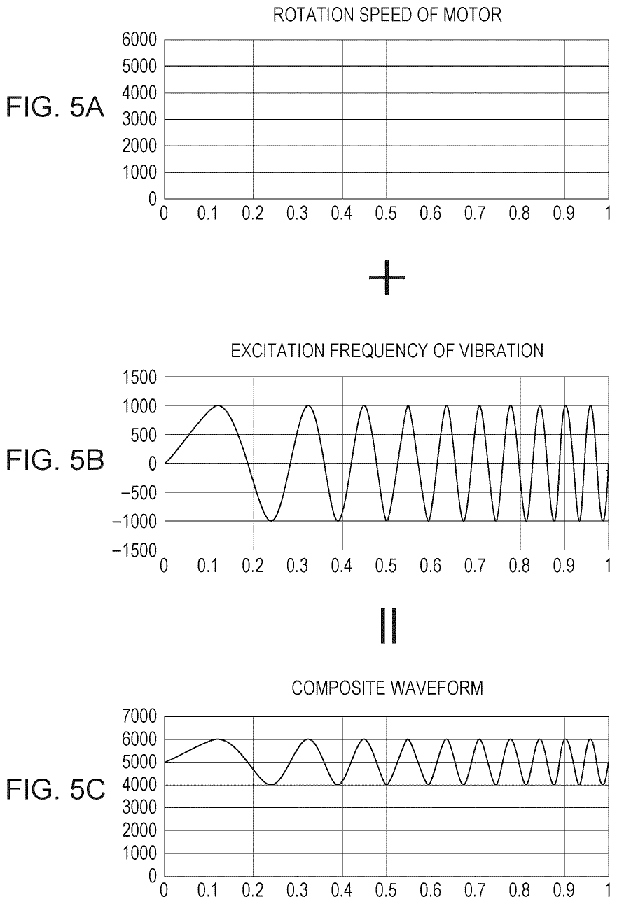

FIGS. 5A, 5B, and 5C illustrate an example of a method of generating the rotation-speed instruction signal Sr to achieve sweep driving.

FIG. 5A illustrates an example of a rotation speed of the motor corresponding to a specified vibration excitation force.

In this example, the rotation speed of the motor is assumed to be controlled to control the vibration excitation force. Namely, specifying the vibration excitation force is equivalent to specifying the rotation speed of the motor in this example. FIG. 5A illustrates a case in which the rotation speed of the motor is set to 5000 rotations per minute (rpm) in accordance with the specified value of the vibration excitation force (a specified value selected from the 10 values in this example).

FIG. 5B illustrates an example of a waveform for sweeping the excitation frequency of vibration.

On the assumption that the rotation speed of the motor 2 is varied within a fixed range of rotation-speed change in the embodiment, sweeping the excitation frequency of vibration is achieved by sweeping the frequency of such a rotation-speed change of the motor 2. For example, on the assumption that the rotation speed of the motor 2 is varied within a range of change of +1000 rpm in this example, the frequency of such a rotation-speed change of +1000 rpm is swept.

Thus, as illustrated in FIG. 5B, the frequency of a sinusoidal wave having a fixed range of change of +1000 rpm is swept to generate a waveform for sweeping the excitation frequency of vibration. Sweeping the frequency is achieved in this example by changing the frequency by a predetermined value (for example, 1 Hz) repeatedly at predetermined intervals from the lowest frequency to the highest frequency of the sweep range specified in the sweep setting screen G2.

The fixed range of rotation-speed change of the motor is set to +1000 rpm as a non-limiting example and may be a different value.

Sweeping the frequency is not limited to gradually increasing the frequency from the lowest frequency to the highest frequency and may be gradually decreasing the frequency from the highest frequency to the lowest frequency.

The motor controller 4 is configured to generate, as the rotation-speed instruction signal Sr for achieving sweep driving, a signal having a composite waveform obtained by the combination of the waveform in FIG. 5A and the waveform in FIG. 5B as illustrated in FIG. 5C.

The motor controller 4 is configured to output to the motor driver 5 the generated rotation-speed instruction signal Sr. The motor driver 5 is configured to drive the motor 2 so that the motor 2 rotates at a rotation speed in accordance with the rotation-speed instruction signal Sr received from the motor controller 4.

In this way, sweep driving is achieved in a mode in accordance with the information specified in the sweep setting screen G2.

In the embodiment, the motor 2 is used to vibrate the vehicle body to reproduce an abnormal sound. Thus, in contrast to the method known in the art, the frequency at which the vehicle body is vibrated is not limited to the rotation frequency of the engine and its harmonics, and the reproducibility of the abnormal sound may be improved.

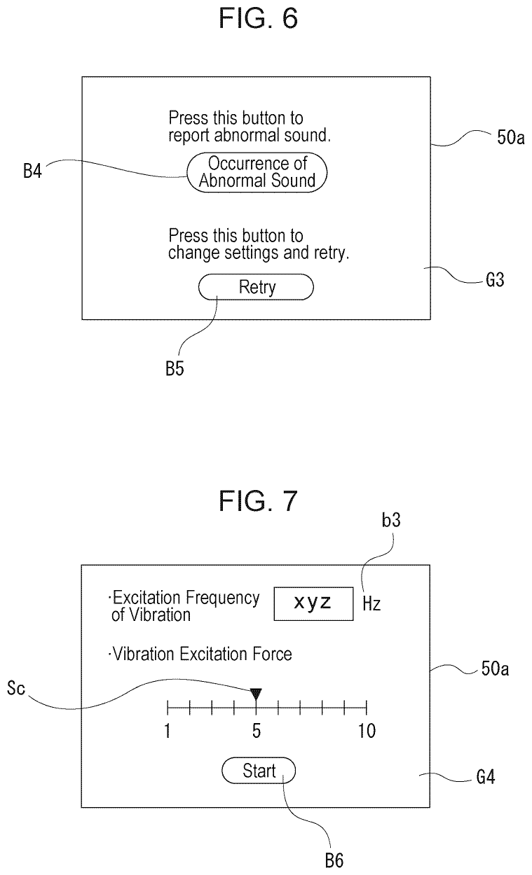

The inspection apparatus 50 is configured to cause the display screen 50a to display a sweep-in-progress screen G3 as illustrated in FIG. 6 in response to the start button B3 being operated in the sweep setting screen G2.

As illustrated in FIG. 6, the sweep-in-progress screen G3 is configured to display an abnormal-sound occurrence reporting button B4 and a retry button B5.

In this example, the user is assumed to report the occurrence of an abnormal sound to the inspection apparatus 50 when the abnormal sound occurs while the excitation frequency of vibration is being changed by sweep driving. Thus, the sweep-in-progress screen G3, which is displayed after the start of sweep driving, contains the abnormal-sound occurrence reporting button B4 for sending a report of the occurrence of the abnormal sound.

In addition, when an abnormal sound is not reproduced by sweep driving, sweep driving is allowed to be retried in this example after the settings of the sweep range and the vibration excitation force are modified. The retry button B5 in the sweep-in-progress screen G3 is configured to report to the inspection apparatus 50 the intention to retry sweep driving.

The inspection apparatus 50 is configured to cause the display screen 50a to display the sweep setting screen G2 (refer to FIG. 4) again in response to the retry button B5 being operated.

In this way, the user is allowed to provide an instruction to modify the sweep range and the vibration excitation force and also provide an instruction to start sweep driving (that is, an instruction to retry sweep driving) in accordance with the modified sweep range and the modified vibration excitation force.

In contrast, the inspection apparatus 50 is configured to send a report of the occurrence of an abnormal sound to the motor controller 4 in response to the abnormal-sound occurrence reporting button B4 being operated when the abnormal sound is generated by sweep driving.

The motor controller 4 is configured to, in response to the report of the occurrence of the abnormal sound, save, as an abnormal-sound occurrence frequency, the excitation frequency of vibration at which the report of the occurrence of the abnormal sound is sent. The motor controller 4 is also configured to report the abnormal-sound occurrence frequency to the inspection apparatus 50.

In addition, the inspection apparatus 50 is configured to cause the display screen 50a to display a constant-frequency setting screen G4 as illustrated in FIG. 7 in response to the abnormal-sound occurrence reporting button B4 being operated.

In the process of diagnosing an abnormal sound in the embodiment, after sweep driving is performed to identify the abnormal-sound occurrence frequency, the excitation frequency of vibration is fixed at the abnormal-sound occurrence frequency, and the motor 2 is driven at this frequency (referred to as “constant-frequency driving”, hereinafter).

Since continuous generation of the abnormal sound becomes possible with this method, such constant-frequency driving helps to facilitate the identification of the source of the abnormal sound.

The constant-frequency setting screen G4 illustrated in FIG. 7 is designed to configure such constant-frequency driving.

As illustrated in FIG. 7, the constant-frequency setting screen G4 displays an input box b3 for specifying the excitation frequency of vibration for constant-frequency driving, a specifying operation element Sc for specifying the vibration excitation force for constant-frequency driving, and a start button B6 to provide an instruction to start constant-frequency driving.

In this example, as the default value of the excitation frequency of vibration, the inspection apparatus 50 displays in the input box b3 the value of the abnormal-sound occurrence frequency received from the motor controller 4.

This allows the user to dispense with inputting a value of the excitation frequency of vibration, and the user's operation load for diagnosing an abnormal sound may be reduced.

The value in the input box b3 may also be changed from the default value.

Although FIG. 7 also illustrates an example of a GUI in which the specifying operation element Sc is used to point to a value of the vibration excitation force in the constant-frequency setting screen G4 as in FIG. 4, the GUI for specifying the vibration excitation force in the constant-frequency setting screen G4 is not limited to the type of using the specifying operation element Sc, either, and various types of GUI are possible.

Operating the start button B6 in the constant-frequency setting screen G4, the user may instruct the inspection apparatus 50 to start constant-frequency driving at the excitation frequency of vibration indicated by the input value in the input box b3 with the vibration excitation force pointed to by the specifying operation element Sc.

The inspection apparatus 50 is configured to provide the motor controller 4 with an instruction to start constant-frequency driving in response to the start button B6 being operated. The instruction to start constant-frequency driving is accompanied by the specification of the excitation frequency of vibration and the vibration excitation force provided in the constant-frequency setting screen G4.

The motor controller 4 is configured to, in response to the instruction to start constant-frequency driving received from the inspection apparatus 50, cause the motor driver 5 to perform constant-frequency driving in accordance with the excitation frequency of vibration and the vibration excitation force specified by the instruction to start constant-frequency driving.

For example, the motor controller 4 is configured to cause the motor driver 5 to perform constant-frequency driving of the motor 2 by outputting to the motor driver 5 a signal having a waveform described below as the rotation-speed instruction signal Sr. The rotation-speed instruction signal Sr has a waveform having a predetermined range of rotation-speed change (a range of change of ±1000 rpm in this example) around a rotation speed as a reference determined in accordance with the specified vibration excitation force (the rotation speed at the center of the rotation-speed change), and the frequency of the rotation-speed change is equal to the specified excitation frequency of vibration.

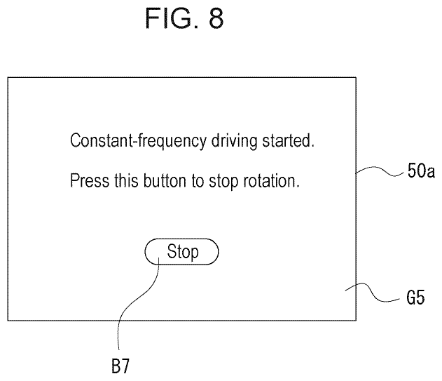

The inspection apparatus 50 is also configured to cause the display screen 50a to display a rotation-in-progress screen G5 illustrated in FIG. 8 in response to the start button B6 being operated in the constant-frequency setting screen G4.

The rotation-in-progress screen G5 displays a stop button B7 to allow the user to provide an instruction to stop constant-frequency driving.

The inspection apparatus 50 is configured to instruct the motor controller 4 to stop constant-frequency driving in response to the stop button B7 being operated.

The motor controller 4 is configured to perform a process of stopping constant-frequency driving in response to the instruction to stop constant-frequency driving received from the inspection apparatus 50.

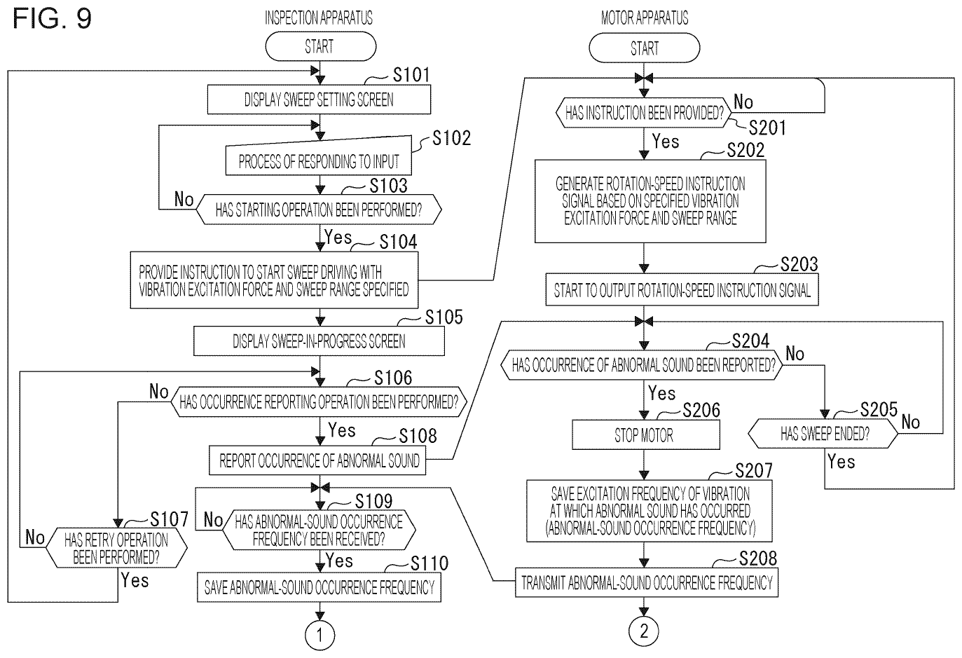

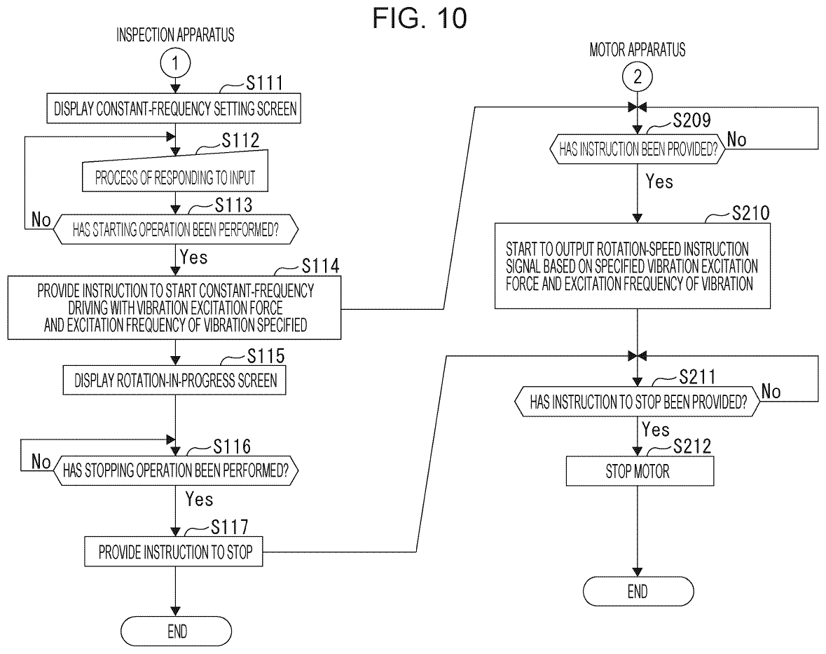

Referring to a flowchart in FIG. 9 and FIG. 10, description will be given with regard to a concrete example of respective procedures to be performed by the inspection apparatus 50 and the motor controller 4 to implement the method of reproducing an abnormal sound according to the embodiment described above.

In FIG. 9 and FIG. 10, the process on the inspection apparatus 50 side is performed by the CPU in the inspection apparatus 50 in accordance with the programs stored in a predetermined storage device (recording medium) such as a ROM in the inspection apparatus 50, and the process on the motor controller 4 side is performed by the CPU in the motor controller 4 in accordance with the programs stored in a predetermined storage device (recording medium) such as a ROM in the motor controller 4.

For the sake of description, the inspection apparatus 50 is assumed to perform the process on the inspection apparatus 50 side, and the motor controller 4 is assumed to perform the process on the motor controller 4 side.

It is assumed that the inspection apparatus 50 has been communicatively coupled to the motor controller 4 and the “Yes” button B1 has been operated in the start screen G1 illustrated in FIG. 3 before a series of procedures illustrated in FIG. 9 and FIG. 10 starts.

First, the inspection apparatus 50 performs a process of displaying the sweep setting screen G2 in step S101. Namely, the inspection apparatus 50 causes the display screen 50a to display the sweep setting screen G2 in response to the “Yes” button B1 being operated in the start screen G1.

The inspection apparatus 50 performs a process of responding to the input in step S102 that follows step S101 until it is determined in step S103 that follows step S102 that a starting operation has been performed. The starting operation to be recognized in step S103 is an operation on the start button B3 (that is, an instruction to start sweep driving). The process of responding to the input in step S102 corresponds to a process of changing a screen display in response to an operation of entering numerical values into the input boxes b1 and b2 and an operation on the specifying operation element Sc in the sweep setting screen G2.

Upon determining in step S103 that the start button B3 has been operated and that the starting operation has been performed, the inspection apparatus 50 proceeds to step S104 and provides an instruction to start sweep driving with the vibration excitation force and the sweep range specified.

Namely, the inspection apparatus 50 instructs the motor controller 4 to start sweep driving based on the vibration excitation force and the sweep range specified by the operation on the sweep setting screen G2.

The inspection apparatus 50 performs a process of displaying the sweep-in-progress screen G3 in step S105 that follows step S104.

Upon performing the process of displaying in step S105, the inspection apparatus 50 enters a loop in steps S106 and S107 to wait for either an occurrence reporting operation or a retry operation. The occurrence reporting operation to be recognized in step S106 is an operation on the abnormal-sound occurrence reporting button B4, and the retry operation to be recognized in step S107 is an operation on the retry button B5.

Upon determining in step S107 that the retry button B5 has been operated and that the retry operation has been performed, the inspection apparatus 50 returns to step S101 and performs the process of displaying the sweep setting screen G2 again.

In contrast, upon determining in step S106 that the abnormal-sound occurrence reporting button B4 has been operated and that the occurrence reporting operation has been performed, the inspection apparatus 50 proceeds to step S108 and sends a report of the occurrence of an abnormal sound to the motor controller 4.

In step S201 on the vehicle 1 side, the motor controller 4 waits to receive the instruction to start sweep driving provided in step S104 described above.

In response to the instruction to start sweep driving, the motor controller 4 performs a process of generating the rotation-speed instruction signal Sr in step S202 based on the vibration excitation force and the sweep range that have been specified. The method of generating the rotation-speed instruction signal Sr to achieve sweep driving has been described with reference to FIGS. 5A, 5B, and 5C, and duplicate description will not be given.

In step S203 that follows step S202, the motor controller 4 starts to output the rotation-speed instruction signal Sr generated in step S202 to the motor driver 5 as a process of starting to output the rotation-speed instruction signal Sr.

In this way, sweep driving starts to reproduce an abnormal sound.

Upon performing the process in step S203, the motor controller 4 enters a loop in steps S204 and S205 to wait for either a report of the occurrence of an abnormal sound or the end of sweep.

The end of sweep in step S205 means that sweep driving in the specified sweep range has ended. In step S205, the end of sweep is recognized when no abnormal sound is reproduced during sweep driving and an instruction to retry is provided on the inspection apparatus 50 side.

Upon recognizing the end of sweep in step S205, the motor controller 4 returns to step S201. This allows the motor controller 4 to be prepared for retry and wait to receive from the inspection apparatus 50 an instruction to start sweep driving for retry.

In contrast, upon determining in step S204 that the report of the occurrence of the abnormal sound, which is sent in step S108 on the inspection apparatus 50 side, has been received, the motor controller 4 proceeds to step S206, performs a process of instructing the motor driver 5 to stop the rotation of the motor 2 as a control to stop the motor, and subsequently in step S207, performs a process of saving the excitation frequency of vibration at which the abnormal sound has occurred (that is, the abnormal-sound occurrence frequency described above). For example, the motor controller 4 saves the abnormal-sound occurrence frequency to a storage device available for the CPU in the motor controller 4 to retrieve and write data, such as the RAM included in the motor controller 4.

The motor controller 4 subsequently performs a process of transmitting the abnormal-sound occurrence frequency to the inspection apparatus 50 in step S208.

Upon performing the process of transmitting in step S208, the motor controller 4 proceeds to step S209 illustrated in FIG. 10.

The inspection apparatus 50 waits to receive the abnormal-sound occurrence frequency from the motor controller 4 in step S109 that follows step S108 (sending the report of the occurrence of the abnormal sound) described above.

Upon receiving the abnormal-sound occurrence frequency, the inspection apparatus 50 performs a process of saving the abnormal-sound occurrence frequency in step S110. For example, the inspection apparatus 50 saves the abnormal-sound occurrence frequency to a storage device available for the CPU in the inspection apparatus 50 to retrieve and write data, such as the RAM included in the inspection apparatus 50.

Upon performing the process of saving in step S110, the inspection apparatus 50 proceeds to step S111 illustrated in FIG. 10.

In FIG. 10, the inspection apparatus 50 performs a process of displaying the constant-frequency setting screen G4 in step S111. In response to the abnormal-sound occurrence reporting button B4 being operated in the sweep-in-progress screen G3 (step S106), the display screen 50a displays the constant-frequency setting screen G4 in this way.

The inspection apparatus 50 performs a process of responding to the input in step S112 that follows step S111 until it is determined in step S113 that follows step S112 that a starting operation has been performed. The starting operation to be recognized in step S113 is an operation on the start button B6 (that is, an instruction to start constant-frequency driving). The process of responding to the input in step S112 corresponds to a process of changing a screen display in response to an operation to input numerical values into the input box b3 and an operation on the specifying operation element Sc in the constant-frequency setting screen G4.

Upon determining in step S113 that the start button B6 has been operated and that the starting operation has been performed, the inspection apparatus 50 proceeds to step S114 and provides an instruction to start constant-frequency driving with the vibration excitation force and the excitation frequency of vibration specified.

Namely, the inspection apparatus 50 instructs the motor controller 4 to start constant-frequency driving based on the vibration excitation force and the excitation frequency of vibration specified by the operation on the constant-frequency setting screen G4.

The inspection apparatus 50 performs a process of displaying the rotation-in-progress screen G5 in step S115 that follows step S114.

In step S116 that follows step S115, the inspection apparatus 50 performs a process of waiting for a stopping operation, that is, waiting for the stop button B7 to be operated.

Upon determining in step S116 that the stop button B7 has been operated and that the stopping operation has been performed, the inspection apparatus 50 instructs the motor driver 5 to stop operation, that is, instructs the motor driver 5 to stop constant-frequency driving in step S117.

Upon instructing the motor driver 5 to stop operation in step S117, the inspection apparatus 50 finishes the series of procedures illustrated in FIG. 9 and FIG. 10.

In step S209, the motor controller 4 waits to receive the instruction to start (the instruction to start constant-frequency driving) provided in step S114 on the inspection apparatus 50 side described above.

In response to the instruction to start provided in step S114, the motor controller 4 proceeds to step S210 to perform a process of starting to output the rotation-speed instruction signal Sr based on the vibration excitation force and the excitation frequency of vibration that have been specified. Namely, the motor controller 4 starts to output the rotation-speed instruction signal Sr to the motor driver 5 to achieve constant-frequency driving with the vibration excitation force and the excitation frequency of vibration specified.

Detailed description has been given with regard to the rotation-speed instruction signal Sr for achieving constant-frequency driving with the vibration excitation force and the excitation frequency of vibration specified, and duplicate description will not be given.

In step S211 that follows step S210, the motor controller 4 waits to receive the instruction to stop from the inspection apparatus 50, that is, the instruction to stop constant-frequency driving provided in step S117.

In response to the instruction to stop, the motor controller 4 performs a process of instructing the motor driver 5 to stop the rotation of the motor 2 as a control to stop the motor in step S212.

Upon instructing the motor driver 5 to stop the rotation of the motor 2 in step S212, the motor controller 4 finishes the series of procedures illustrated in FIG. 9 and FIG. 10.

The embodiment is not limited to the example described above, and various modifications to the configuration are possible.

In the above example, the rotation speed of the motor 2 is controlled to control the vibration excitation force, but the vibration excitation force may also be controlled by controlling the range of rotation-speed change of the motor 2.

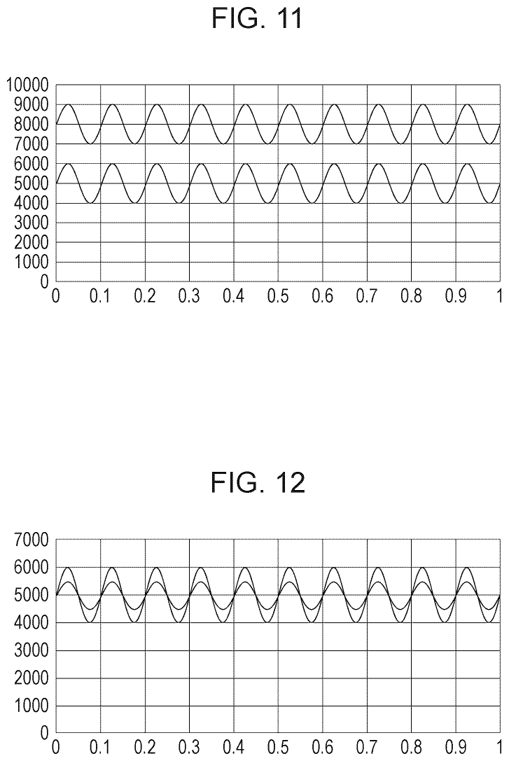

For reference, FIG. 11 illustrates a schematic representation of waveforms for controlling the vibration excitation force using the rotation speed of the motor 2, and FIG. 12 illustrates a schematic representation of waveforms for controlling the vibration excitation force using the range of rotation-speed change of the motor 2.

As illustrated in FIG. 11, when the vibration excitation force is controlled using the rotation speed, the range of rotation-speed change is set to a predetermined value (for example, +1000 rpm), and the vibration excitation force is controlled by controlling the rotation speed at the center of the rotation-speed change (reference rotation speed of the motor). FIG. 11 illustrates a waveform for the reference rotation speed of the motor set to 5000 rpm and a waveform for the reference rotation speed of the motor set to 8000 rpm. Note that the vibration excitation force tends to increase as the reference rotation speed of the motor increases.

When sweep driving is performed, the frequency of the rotation-speed change may be gradually changed for the waveforms illustrated in FIG. 11.

In contrast, as illustrated in FIG. 12, when the vibration excitation force is controlled using the range of rotation-speed change, the reference rotation speed of the motor is fixed, and the vibration excitation force is controlled by controlling the range of rotation-speed change. FIG. 12 illustrates a waveform for the range of rotation-speed change set to +500 rpm and a waveform for the range of rotation-speed change set to +1000 rpm while the reference rotation speed of the motor is fixed at 5000 rpm. In this case, the vibration excitation force tends to increase as the range of rotation-speed change increases.

When sweep driving is performed, the frequency of the rotation-speed change may be gradually changed for the waveforms illustrated in FIG. 12.

Although not mentioned above in particular, when sweep driving or constant-frequency driving is performed, a jig such as disclosed in Japanese Patent No. 5350305 may be used to facilitate transmission of vibration from the motor 2 to the vehicle body (that is, facilitate generation of an abnormal sound).

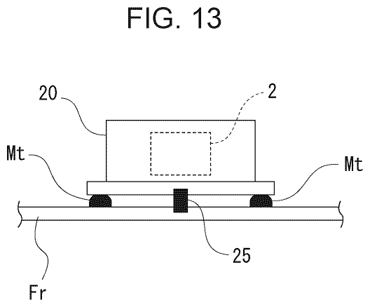

For example, a jig 25 is prepared that differs from a mounting member Mt joining a power unit 20 including the motor 2 to the body frame (referred to as “Fr” hereinafter) of the vehicle 1, and sweep driving or constant-frequency driving is performed with the power unit 20 joined to the body frame Fr using the jig 25 (refer to FIG. 13).

In this case, a damping restriction member capable of restricting the damping function of the mounting member Mt is used as the jig 25. For example, the jig 25 may be made of metal whereas the mounting member Mt is made of resin. In this case, the jig 25 may be joined to the body frame Fr, for example, using bolts and nuts as in Japanese Patent No. 5350305.

The power unit 20 may include a constituent element used to drive wheels in addition to the motor 2 and, for example, may be a unit including the motor 2 and a transmission mechanism.

As described above, a controller (motor controller 4) according to the embodiment of the disclosure is a controller for a vehicle (vehicle 1) equipped with a motor (motor 2) for running; the controller includes one or more processors (CPU in the motor controller 4) and one or more recording media (ROM in the motor controller 4) storing a program to be executed by the one or more processors. The program includes one or more instructions configured to cause the one or more processors to perform a sweep driving process including sweeping an excitation frequency of vibration applied to a vehicle body by the motor while driving the motor during an inspection of the vehicle.

As described above, the motor for running is used to vibrate the vehicle body, and the excitation frequency of vibration applied to the vehicle body by the motor is swept. In this method, in contrast to the method known in the art, the frequency at which the vehicle body is vibrated is not limited to the rotation frequency of the engine and its harmonics, and the reproducibility of an abnormal sound may be improved.

In the method of reproducing an abnormal sound according to the embodiment, an actually running vehicle is not used to reproduce an abnormal sound, and a vibration exciter is also dispensed with. Thus, when an abnormal sound is safely reproduced without a vehicle actually being driven, the method of reproducing an abnormal sound according to the embodiment may improve the reproducibility of the abnormal sound as well as reducing cost since a vibration exciter is dispensed with.

In the controller according to the embodiment, the sweep driving process includes sweeping the excitation frequency of vibration while a vibration excitation force applied to the vehicle body by the motor is maintained at a value specified by a user operation.

Thus, the user operation may be used to change the vibration excitation force applied while the excitation frequency of vibration is being swept.

Since the vibration excitation force may be changed, an abnormal sound may be generated, for example, by retrying a frequency sweep with the vibration excitation force increased even when a frequency sweep at a certain vibration excitation force fails to generate the abnormal sound. Thus, the reproducibility of the abnormal sound may be improved, facilitating the identification of the source of the abnormal sound.

In the controller according to the embodiment, the program includes, as the one or more instructions, an instruction to cause the processor to, after performing the sweep driving process, perform a constant-frequency driving process including driving the motor at the excitation frequency of vibration set to a specified constant frequency.

In this way, after performing the sweep driving process to identify the excitation frequency of vibration at which an abnormal sound occurs, the controller may drive the motor while maintaining the excitation frequency of vibration at the specified constant value, in other words, may keep generating the abnormal sound while driving the motor.

Thus, the identification of the source of the abnormal sound may be facilitated.

Further, in the controller according to the embodiment, the sweep driving process includes sweeping the excitation frequency of vibration based on input information provided by a user operation received by an apparatus (inspection apparatus 50) external to the vehicle.

Thus, when diagnosing an abnormal sound, a user such as a mechanic from a dealer may operate the apparatus external to the vehicle.

Since implementing a UI function in the vehicle is not necessary to diagnose an abnormal sound, vehicle-side resources may be reduced.

Further, in the controller according to the embodiment, the sweep driving process includes sweeping the excitation frequency of vibration while a power unit (power unit 20) including the motor is joined to a body frame (body frame Fr) by using a jig (jig 25) differing from a mounting member (mounting member Mt) configured to join the power unit to the body frame.

The above jig is configured to facilitate the transmission of vibration from the motor to the body frame.

Thus, the reproducibility of the abnormal sound may be further improved, facilitating the identification of the source of the abnormal sound.

The motor controller 4 illustrated in FIG. 2 can be implemented by circuitry including at least one semiconductor integrated circuit such as at least one processor (e.g., a central processing unit (CPU)), at least one application specific integrated circuit (ASIC), and/or at least one field programmable gate array (FPGA). At least one processor can be configured, by reading instructions from at least one machine readable tangible medium, to perform all or a part of functions of the motor controller 4. Such a medium may take many forms, including, but not limited to, any type of magnetic medium such as a hard disk, any type of optical medium such as a CD and a DVD, any type of semiconductor memory (i.e., semiconductor circuit) such as a volatile memory and a non-volatile memory. The volatile memory may include a DRAM and a SRAM, and the non-volatile memory may include a ROM and a NVRAM. The ASIC is an integrated circuit (IC) customized to perform, and the FPGA is an integrated circuit designed to be configured after manufacturing in order to perform, all or a part of the functions of the modules illustrated in FIG. 2.

1. A controller for a vehicle equipped with a motor for running, the controller comprising:
one or more processors; and
one or more recording media storing a program to be executed by the one or more processors,
wherein the program comprises one or more instructions configured to cause the one or more processors to
perform a sweep driving process comprising sweeping an excitation frequency of vibration applied to a vehicle body of the vehicle by the motor while driving the motor during an inspection of the vehicle.

2. The controller according to claim 1,
wherein the sweep driving process comprises
sweeping the excitation frequency of vibration while a vibration excitation force applied to the vehicle body by the motor is maintained at a value specified by a user operation.

3. The controller according to claim 1,
wherein the program comprises, as the one or more instructions,
an instruction to cause the processor to, after performing the sweep driving process, perform a constant-frequency driving process comprising driving the motor at the excitation frequency of vibration set to a specified constant frequency.

4. The controller according to claim 1,
wherein the sweep driving process comprises
sweeping the excitation frequency of vibration based on input information provided by a user operation received by an apparatus external to the vehicle.

5. The controller according to claim 1,
wherein the sweep driving process comprises
sweeping the excitation frequency of vibration while a power unit comprising the motor is joined to a body frame by using a jig differing from a mounting member configured to join the power unit to the body frame.

6. The controller according to claim 2,
wherein the sweep driving process comprises
sweeping the excitation frequency of vibration while a power unit comprising the motor is joined to a body frame by using a jig differing from a mounting member configured to join the power unit to the body frame.

7. The controller according to claim 3,
wherein the sweep driving process comprises
sweeping the excitation frequency of vibration while a power unit comprising the motor is joined to a body frame by using a jig differing from a mounting member configured to join the power unit to the body frame.

8. The controller according to claim 4,
wherein the sweep driving process comprises
sweeping the excitation frequency of vibration while a power unit comprising the motor is joined to a body frame by using a jig differing from a mounting member configured to join the power unit to the body frame.
